(19) United States
(12) Patent Application Publication
(10) Pub. No.: US 2011/0187867 A1
(43) Pub. Date: Aug. 4, 2011

(54) ACCESS POINT DEVICE AND MONITORING SYSTEM USING THE ACCESS POINT DEVICE

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/824,206

(22) Filed: Jun. 27, 2010

(30) Foreign Application Priority Data
Feb. 4, 2010 (TW) 99103373

(51) Int. Cl. H04N 7/18

(52) U.S. Cl. 348/159; 348/E07.085

(57) ABSTRACT

A monitoring system includes at least one network camera distributed in an area to be monitored, an access point device connected with the at least one network camera. The access point device includes ports, micro control units, and a central processing unit. Each micro control unit is connected to one of the ports, and the central processing unit is connected with the micro control units. The central processing unit assigns an IP pool to each micro control unit and receives captured images from the ports. Each micro control unit assigns an IP address from the IP pool to a corresponding network camera, and manages the captured images according to the IP addresses.

### BACKGROUND

1. Technical Field

Embodiments of the present disclosure generally relate to monitoring technologies, and more particularly to an access point device and a monitoring system using the access point device.

2. Description of Related Art

Network cameras are commonly used in a monitoring system. When there are many network cameras used, each of the network cameras may be assigned an Internet protocol (IP) address for distinguishing them apart. As shown in FIG. 1, a one such monitoring system 100 includes network cameras 2, an access point (AP) device 1, and a monitoring device 3. The AP device 1 comprises a plurality of ports 12 and a central processing unit (CPU) 10. The CPU 10 assigns an IP address to each of the network cameras 2 by using a dynamic host configuration protocol (DHCP) method. For example, the CPU 10 of the AP device 1 presets an IP pool (such as “192.168.1.***”), and uses the DHCP method to randomly assign an IP address from the IP pool to each of the network cameras 2. However, because the IP address of the network cameras 2 are all from one IP pool, the network cameras 2 distributed in different areas are not easily identified by the AP device 1 according to the assigned IP address.

What is needed, therefore, is an improved monitoring system to overcome the limitations described.

### BRIEF DESCRIPTION OF THE DRAWINGS

FIG. 1 is a block diagram of a traditional monitoring system.

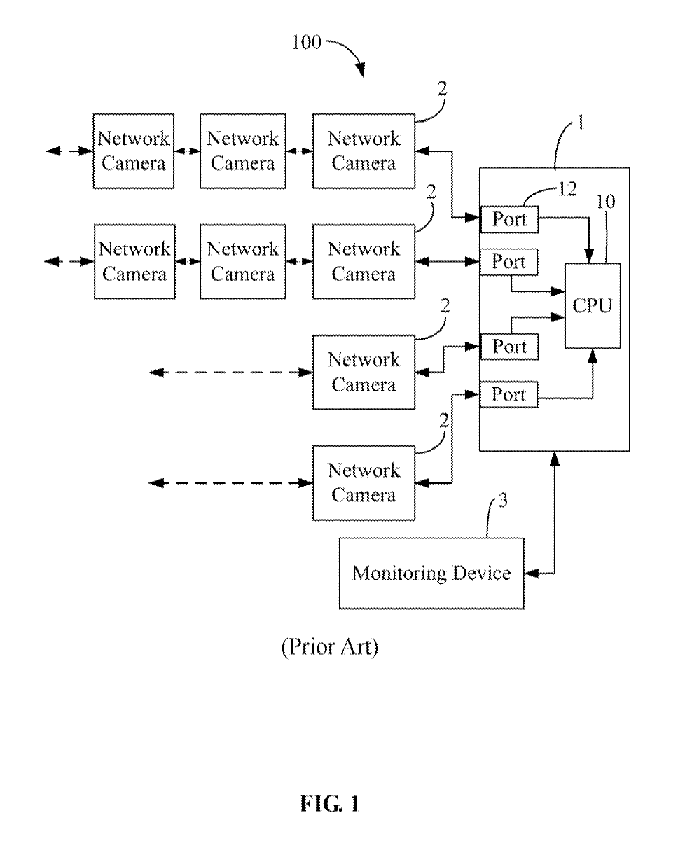

FIG. 2 is a block diagram of one embodiment of a monitoring system including an access point device and a plurality of network cameras.

FIG. 3 is a block diagram of one embodiment of a network camera having a switch.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

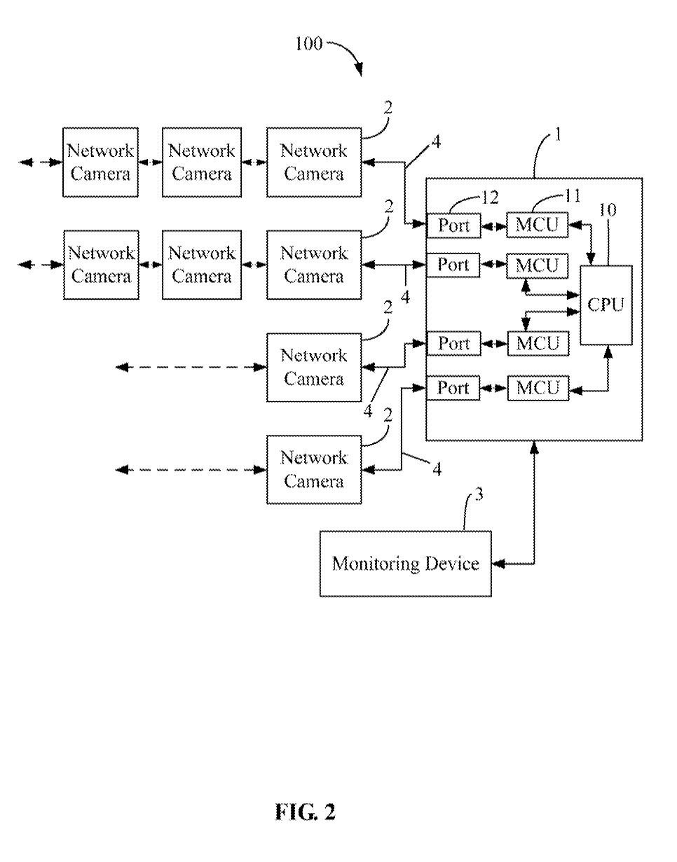

FIG. 2 is a block diagram of one embodiment of a monitoring system 100 including an access point (AP) device 1 and a plurality of network cameras 2. Each of the network cameras 2 is distributed in an area to be monitored, and configured for capturing images of the monitored area. The network cameras 2 in a single monitored area are connected in series. The AP device 1 is connected to the network cameras 2. The AP device 1 includes a plurality of ports 12, a plurality of micro control units (MCUs) 11, and a central processing unit (CPU) 10. Each of the ports 12 is connected to a series of the cameras 2 from a single monitored area. Each of the ports 12 is further connected to one of the MCUs 11. The CPU 10 is connected to the MCUs 11, and distributes an IP pool to each of the MCUs 11. Each of the MCUs 11 is connected to one of the ports 12, and randomly assigns an IP address from the IP pool to each of the network cameras 2 associated with that port 12.

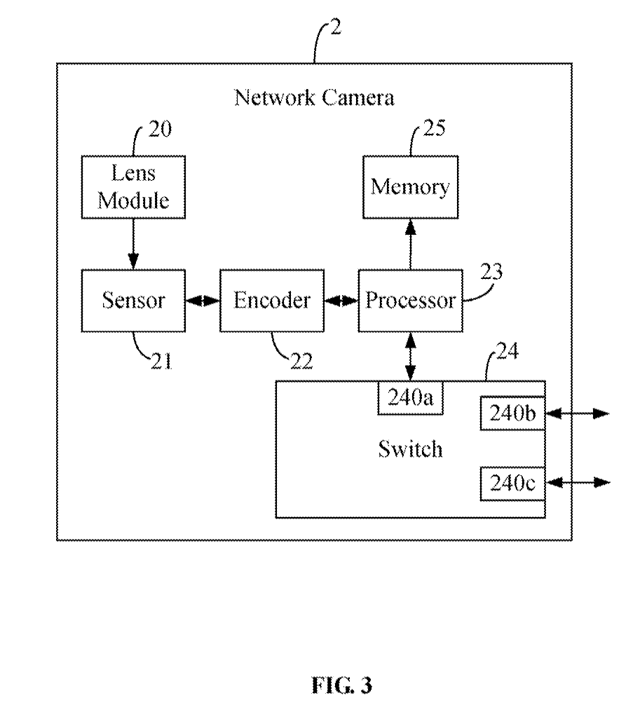

FIG. 3 is a block diagram of one embodiment of a network camera 2 having a switch 24. In the embodiment, each network camera 2 includes a lens module 20, a sensor 21, an encoder 22, a processor 23, and a switch 24, with the components 20-24 connected in series. The lens module 20 is configured for capturing images of the monitored area. The sensor 21 is configured for focusing the lens module 20 on the monitored area. The encoder 22 encodes the captured images, and transmits the encoded images to the processor 23. The processor 23 saves the encoded images in a memory 25. The memory 25 can be a flash memory, for example.

In one embodiment, the switch 24 includes a first port 240a, a second port 240b, and a third port 240c. The first port 240a is connected with the processor 23, and for receiving the processed images. The second port 240b is an extension port of the network camera 2 for connecting to an external device such as another network camera 1, which allows the connection of many network cameras 1 or other devices in series. The third port 240c is connected to a monitoring device 3, and transmits the processed images to the monitoring device 3. In other embodiments, the switch 24 may have more than one second port 240b, for extending the functions of the network camera 2. The monitoring device 3 may be a personal computer, a mobile phone, or a personal digital assistant, for example.

In one embodiment, the first port 240a can be a medium independent interface port or a reduced medium independent interface (MII/RMII) port. The switch 24 can be an ethernet switch. The switch 24 and the processor 23 are connected in series by the MII/RMII port. As illustrated in FIG. 2, the switch 24 can be connected to the AP device 1 via the third port 240c, and transmits the encoded images to the monitoring device 3 via the AP device 1. As the port 240b can connect to a video camera or a network camera, the monitoring device 3 can monitor one or more network cameras 2 utilizing one network cable 4.

In FIG. 2, four network cables 4 distributed in four areas are given as an example, each of the four network cables 4 connects to the network cameras 2 in a single area through the respective port 240b, and all the captured images from each of the network cameras 2 are transmitted to the AP device 2. Each of the ports 12 receives the encoded images of the monitored area. The CPU 10 distributes an IP pool to each of the MCUs 11, and receives the encoded images from the ports 12. Each of the MCUs 11 assigns an IP address from the IP pool to a corresponding network camera 2 using a dynamic host configuration protocol (DHCP) method, and manages the encoded images according to the IP addresses.

For example, if the network cameras “2a,” “2b,” “2c,” and “2d” distributed in an area “A” are connected to the port 12a of the AP device 2, and the port 12a is connected to the MCU 11a, the CPU 10 distributes the IP pool “192.168.2.1˜192.168.2.255” to the MCU 11a. The MCU 11a assigns an IP address from the IP pool “192.168.2.1˜192.168.2.255” to each of the network cameras 2a-2d, and manages the images captured by each of the network cameras 2a-2d according to the IP addresses. The captured images of the network cameras 2a-2d can be transmitted from the AP device 1 to the monitoring device 3 for monitoring via the network cables 4.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An access point device, comprising:
a central processing unit; and
a plurality of ports, each of the ports connected to a plurality of network cameras distributed in a single area to be monitored, and a micro control unit, and each micro control unit connected to the central processing unit;
the central processing unit configured for assigning an Internet protocol (IP) pool to each micro control unit; and
each micro control unit configured for assigning an IP address from the IP pool to a corresponding network camera, and managing images captured by the network cameras according to the IP addresses.

2. The access point device as described in claim 1, wherein each of the network cameras comprises:
a lens module operable to capturing images of an area to be monitored;
a processor configured for saving the captured images in a memory; and
a switch, comprising:
a first port connected to the processor, and configured for receiving the captured images;
a second port being an extension port of the network camera for connecting to an external device; and
a third port configured for transmitting the captured images to a monitoring device.

3. The access point device as described in claim 2, wherein the external device is a network camera.

4. The access point device as described in claim 2, wherein the monitoring device is a personal computer, a mobile phone, or a personal digital assistant.

5. The access point device as described in claim 1, wherein the switch is an ethernet switch.

6. A method for monitoring an area using an access point device, the method comprising:
receiving images captured by a series of network cameras from a single area to a port of the access point device;
assigning an Internet protocol (IP) pool to a micro control unit that is connected to the port of the access point device; and
assigning an IP address from the IP pool to a corresponding network camera connected to the port, and managing the captured images according to the IP addresses.

7. The method as described in claim 6, wherein each of the network cameras comprises:
a lens module operable to capturing images of the monitored area;
a processor configured for saving the captured images in a memory; and
a switch comprising a first port, a second port, and a third port, the first port connected with the processor, and configured for receiving the captured images.

8. The method as described in claim 7, wherein the first port is a medium independent interface port or a reduced medium independent interface port.

9. The method as described in claim 7, wherein the second port is an extension port of the network camera for connecting to an external device.

10. The method as described in claim 9, wherein the external device is a network camera.

11. The method as described in claim 7, wherein the third port is connected with the access point device, and is configured for transmitting the captured images to a monitoring device.

12. The method as described in claim 11, wherein the monitoring device is a personal computer, a mobile phone, or a personal digital assistant.

13. The method as described in claim 7, wherein the switch is an ethernet switch.
